(19) United States
(12) Patent Application Publication
(10) Pub. No.: US 2026/0042361 A1
(43) Pub. Date: Feb. 12, 2026

(54) SELF-LOCATION FEATURES FOR COMPONENT ASSEMBLY

(71) Applicant: GM GLOBAL TECHNOLOGY OPERATIONS LLC, DETROIT, MI (US)

(72) Inventors: Lu Huang, Troy, MI (US); Collins Angelo, Windsor (CA); Odilon Firmino Maillo, Warren, MI (US); Wei Wu, Troy, MI (US); Ryan Curtis Sekol, Grosse Pointe Woods, MI (US); Rodrigo Franca Soares Campos, Rochester Hills, MI (US); Dalwyn C. Williams, Oakland, MI (US); Xianglu Zhang, Shanghai (CN)

(21) Appl. No.: 18/800,395

(22) Filed: Aug. 12, 2024

(51) Int. Cl. B60L 50/64; H01M 50/204; H01M 50/224; H01M 50/249; H01M 50/262; H01M 50/276

(52) U.S. Cl. CPC B60L 50/64; H01M 50/204; H01M 50/224; H01M 50/249; H01M 50/262; H01M 50/276; H01M 2220/20

(57) ABSTRACT

A sheet metal component assembly includes a first component having at least one locating opening formed therein, and a second component installed to the first component. The second component includes a second component body and at least one locating boss formed in and extending from the second component body. The at least one locating boss is installed into the at least one locating opening to position the second component at the first component. A rechargeable energy storage system (RESS) includes a tray, one or more RESS cells positioned on the tray, and a cover installed to the tray to enclose the RESS. The cover includes a cover body, and at least one locating boss formed in and extending from the cover body. The at least one locating boss is installed into at least one locating opening in the tray to position the cover at the tray.

### INTRODUCTION

The subject disclosure relates to assemblies of two components, for example, vehicle components such as rechargeable energy storage systems (RESS's) or battery systems, for vehicles.

A typical RESS assembly includes a cover secured thereto. The assembly process of this cover to the RESS assembly relies on manual operations to properly locate the cover to the RESS assembly, in particular to a tray of the RESS. The manual process is not compatible with assembly facilities with a high degree of automation. It is desired to make the RESS cover installation process feasible and compatible with an automated assembly process, without introducing significant design and manufacturing process changes.

### SUMMARY

In one exemplary embodiment, a sheet metal component assembly includes a first component having at least one locating opening formed therein, and a second component installed to the first component. The second component includes a second component body and at least one locating boss formed in and extending from the second component body. The at least one locating boss is installed into the at least one locating opening to position the second component at the first component.

In addition to one or more of the features described herein the at least one locating boss is one of a continuous cylindrical or conical element extending from the second component body.

In addition to one or more of the features described herein the at least one locating boss includes two or more discontinuous boss legs extending from the second component body.

In addition to one or more of the features described herein at least one leg bridge is spaced apart from the second component body and connects two adjacent boss legs of the two more boss legs.

In addition to one or more of the features described herein the at least one leg bridge is one of substantially linear, W-shaped or U-shaped.

In addition to one or more of the features described herein at least one locating pin is installed in the at least one locating boss and extends into the at least one locating opening.

In addition to one or more of the features described herein the at least one locating boss is formed via one or more of die cutting, punching, laser cutting, waterjet cutting, hole extrusion or flanging.

In another exemplary embodiment, a rechargeable energy storage system (RESS) includes a tray, one or more RESS cells positioned on the tray, and a cover installed to the tray to enclose the RESS. The cover includes a cover body, and at least one locating boss formed in and extending from the cover body. The at least one locating boss is installed into at least one locating opening in the tray to position the cover at the tray.

In addition to one or more of the features described herein the at least one locating boss is one of a continuous cylindrical or conical element extending from the cover body.

In addition to one or more of the features described herein the at least one locating boss includes two or more discontinuous boss legs extending from the cover body.

In addition to one or more of the features described herein at least one leg bridge is spaced apart from the cover body and connects two adjacent boss legs of the two more boss legs.

In addition to one or more of the features described herein the at least one leg bridge is one of substantially linear, W-shaped or U-shaped.

In addition to one or more of the features described herein at least one locating pin is installed in the at least one locating boss and extends into the at least one locating opening.

In addition to one or more of the features described herein the at least one locating boss is formed via one or more of die cutting, punching, laser cutting, waterjet cutting, hole extrusion or flanging.

In yet another exemplary embodiment, a vehicle includes a vehicle body, a propulsion system to drive a movement of the vehicle, and a rechargeable energy storage system (RESS) operably connected to the propulsion system to power the propulsion system. The RESS includes a tray, one or more RESS cells positioned on the tray, and a cover installed to the tray to enclose the RESS. The cover includes a cover body, and at least one locating boss formed in and extending from the cover body. The at least one locating boss is installed into at least one locating opening in the tray to position the cover at the tray.

In addition to one or more of the features described herein the at least one locating boss is one of a continuous cylindrical or conical element extending from the cover body.

In addition to one or more of the features described herein the at least one locating boss includes two or more discontinuous boss legs extending from the cover body.

In addition to one or more of the features described herein at least one leg bridge is spaced apart from the cover body and connects two adjacent boss legs of the two more boss legs.

In addition to one or more of the features described herein the at least one leg bridge is one of substantially linear, W-shaped or U-shaped.

In addition to one or more of the features described herein at least one locating pin is installed in the at least one locating boss and extends into the at least one locating opening.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of an exemplary embodiment of a vehicle;

FIG. 2 is a schematic cross-sectional illustration of an embodiment of an RESS of a vehicle;

FIG. 3 is a schematic cross-sectional illustration of an embodiment of a tray locating feature;

FIG. 4 is a schematic cross-sectional illustration of another embodiment of a tray locating feature;

FIG. 5 is a plan view of a cutout pattern of an embodiment of a discontinuous tray locating feature;

FIG. 6 is a perspective view of the embodiment of FIG. 5;

FIG. 7 is a plan view of a cutout pattern of another embodiment of a discontinuous tray locating feature;

FIG. 8 is a perspective view of the embodiment of FIG. 7;

FIG. 9 is a plan view of a cutout pattern of an embodiment of a discontinuous tray locating feature including a leg bridge;

FIG. 10 is a perspective view of the embodiment of FIG. 9;

FIG. 11 is a plan view of a cutout pattern of another embodiment of a discontinuous tray locating feature including a leg bridge;

FIG. 12 is a plan view of a cutout pattern of another embodiment of a discontinuous tray locating feature including a leg bridge;

FIG. 13 is a perspective view of the embodiment of FIG. 12;

FIG. 14 is a plan view of a cutout pattern of yet another embodiment of a discontinuous tray locating feature including a leg bridge;

FIG. 15 is a perspective view of the embodiment of FIG. 14;

FIG. 16 is a plan view of a cutout pattern of still another embodiment of a discontinuous tray locating feature including a leg bridge;

FIG. 17 is a perspective view of the embodiment of FIG. 16;

FIG. 18 is a plan view of a cutout pattern of another embodiment of a discontinuous tray locating feature including a leg bridge;

FIG. 19 is a perspective view of the embodiment of FIG. 18; and

FIG. 20 is a partial cross-sectional view of an embodiment including a locating pin.

### DETAILED DESCRIPTION

The following description is merely exemplary in nature and is not intended to limit the present disclosure, its application or uses. It should be understood that throughout the drawings, corresponding reference numerals indicate like or corresponding parts and features.

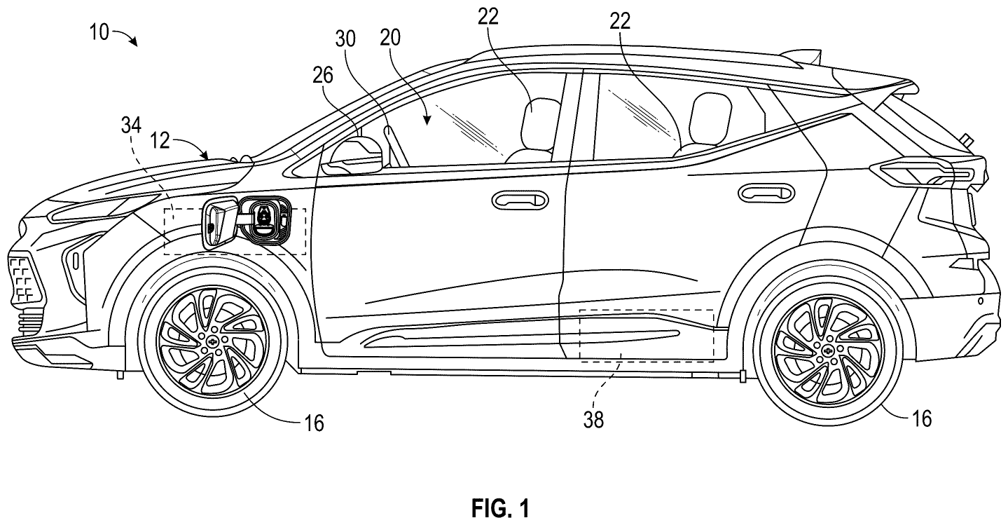

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, a passenger compartment 20 having seats 22 positioned behind a dashboard 26. A steering control 30 is arranged between seats 22 and dashboard 26. Steering control 30 is operated to control orientation of the steerable wheel(s). Vehicle 10 includes an electric motor 34 connected to a transmission that provides power to one or more of the plurality of wheels 16. A rechargeable energy storage system (RESS) assembly 38 provides power to the electric motor 34.

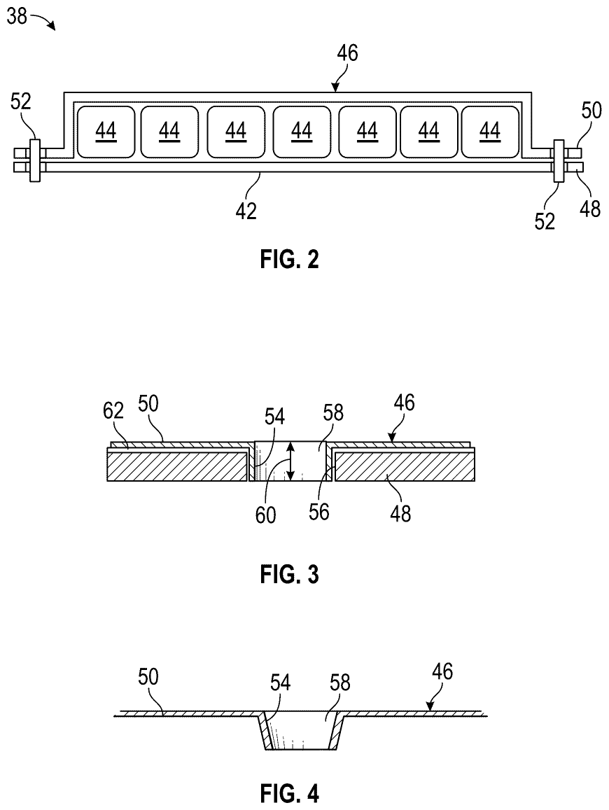

Referring now to FIG. 2, illustrated is a cross-sectional view of an exemplary embodiment of an RESS assembly 38. The RESS assembly 38 includes a tray 42 with a plurality of cells 44 disposed therein. To enclose the RESS assembly 38, a cover 46 is installed thereto. The tray 42 includes a tray flange 48 that in some embodiments defines an outer perimeter of the tray 42. Similarly, the cover 46 includes a cover flange 50 that in some embodiments defines an outer perimeter of the cover 46. To secure the cover 46 to the tray 42, a plurality of fasteners 52 are installed through the cover flange 50 and the tray flange 48. In some embodiments, the cover 46 and/or the tray 42 are formed from a sheet metal material. One skilled in the art, however, will readily appreciate that the cover 46 and/or the tray 42 may be formed from another material such as a plastic or fiber reinforced composite material.

While the following description is in the context of a RESS assembly 38, one skilled in the art will readily appreciate that the present disclosure may be readily applied to other assemblies of two components. During the assembly process, it is desired to accurately and simply locate the cover 46 onto the tray 42 prior to installation of the plurality of fasteners 52. Referring now to FIG. 3, the cover 46 includes one or more locating bosses 54 formed in the cover flange 50. These locating bosses 54 are inserted into corresponding locating openings 56 in the tray flange 48. While this arrangement is illustrated and described herein, one skilled in the art will readily appreciate that in some embodiments, the configuration may be substantially reversed, with the locating bosses 54 formed in the tray flange 48 and inserted into corresponding locating openings 56 in the cover flange 50 to locate the cover 46 relative to the tray 42 during assembly. In the embodiment of FIG. 3, the locating boss 54 is continuous around a boss opening 58 in the cover flange 50, and extends perpendicular to the cover flange 50 into the locating opening 56 in the tray flange 48. In this configuration, the boss opening 58 is formed in the cover flange 50, and the locating boss 54 is formed by, for example, an extrusion process. In another embodiment, such as shown in FIG. 4, the locating boss 54 may be formed in another shape by extrusion. For example, in the embodiment of FIG. 4, the locating boss 54 has a frustoconical shape. In some embodiments, shown best in FIG. 3, the locating boss 54 has a boss height 60 that achieves a minimum height of greater than a thickness of an adhesive layer 62 between the tray flange 48 and the cover flange 50, to ensure that the locating boss 54 is at least partially inserted into the locating opening 56. In some embodiments, a minimum boss height 60 is greater than or equal to 7 millimeters.

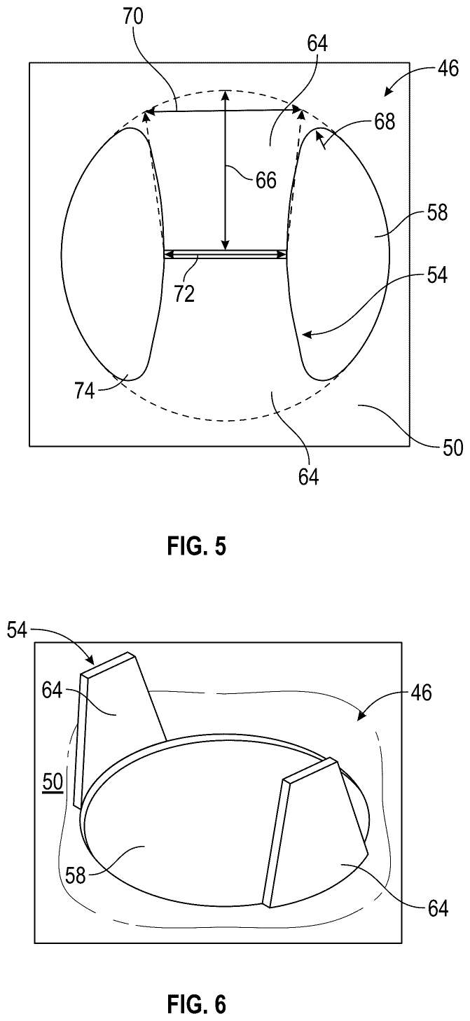

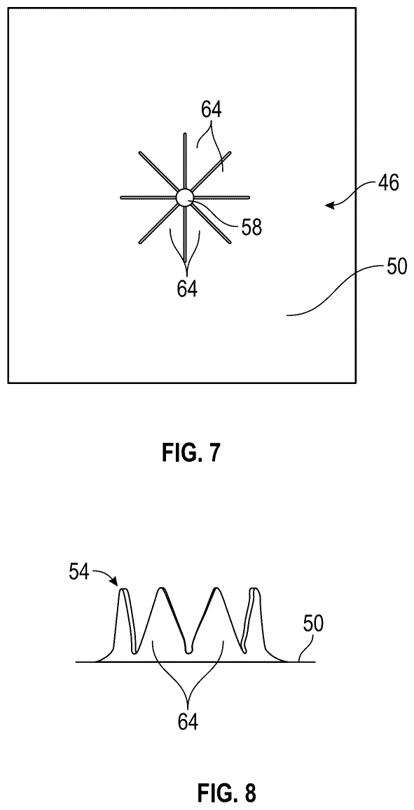

In other embodiments, the locating boss 54 is discontinuous around the boss opening 58 as illustrated in FIGS. 5-8. The locating boss 54 has one or more boss legs 64 positioned around the boss opening 58. In some embodiments, such as in FIGS. 5 and 6, the locating boss 54 includes two boss legs 64. The boss opening 58 is cut to form a cutout pattern, such as illustrated in FIG. 5, that when formed after cutting, the boss legs 64 extend outwardly from the cover flange 50, such as shown in FIG. 6. Referring again to FIG. 5, the locating boss 54 configuration may be varied by number of boss legs 64 and their symmetry, size of the boss opening 58, leg length 66, leg fillet radius 68, and other parameters such a leg base width 70 and leg tip width 72. One skilled in the art will readily appreciate that the listed parameters are merely exemplary and that other parameters may be utilized, depending on the configuration of the locating boss 54. In another embodiment, such as shown in FIGS. 7 and 8, varying these parameters may result in boss legs 64 that are substantially triangular in length, where the leg tip width 72 is at or near zero. Referring again to FIG. 5, in some embodiments stress relief cuts may be incorporated into the fillet region 74 of the locating boss 54 to reduce the risk of fracture. Additionally, during forming after cutting some degree of stretching of the material may be performed to increase an overall stiffness of the locating boss 54, if formability of the material allows for such.

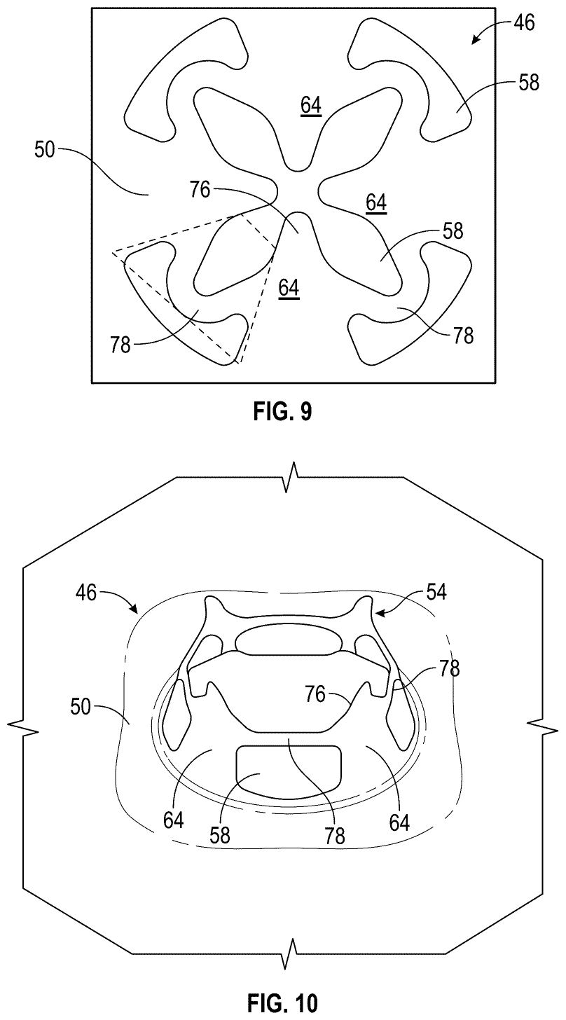

In other embodiments, as illustrated in FIGS. 9 and 10, the locating boss 54 includes the plurality of boss legs 64, with adjacent boss legs 64 interconnected at or near a leg tip 76 by a leg bridge 78 extending between the two adjacent boss legs 64. Utilizing the leg bridge 78 increases overall structural integrity and stiffness of the locating boss 54 while still allowing for accurate location of the cover 46 to the tray 42. The leg bridges 78 are configured to have a sufficient length when formed in the flat state, shown in FIG. 9, to allow for straightening and reshaping without introducing stretching when formed into the locating boss 54 configuration shown in FIG. 10. Additionally, it is desired to avoid stress concentrations in the leg bridges 78 by utilizing relatively large fillet radii.

Referring now to FIG. 11, the locating boss 54 including leg bridges 78 is configured by varying key parameters such as a bridge length 80, which must be long enough to avoid fracture of the leg bridge when the locating boss is formed. A bridge outer opening angle 82 must be large enough to enable the required bridge length 80 and not too large as to reduce rigidity of the structure. The leg bridge 78 includes an inner opening angle 84 defined between the leg bridge 78 and the adjacent boss leg 64. This inner opening angle 84 is sized to be large enough to reduce stress concentrations between the leg bridge 78 and the boss leg 64 during reforming from the flat configuration of FIG. 11 to the extended configuration of FIG. 10. If the inner opening angle 84 is too large, however, it undesirably reduces a size of the boss leg 64. An inner bridge radius 86 is sized to reduce strain concentrations when forming to the extended configuration. An outer bridge distance 88 from a boss axis 90 determines a position of the leg bridge 78 along the boss leg 64, while an inner bridge distance 92, together with the outer bridge distance 88, determines a bridge width of the leg bridge 78.

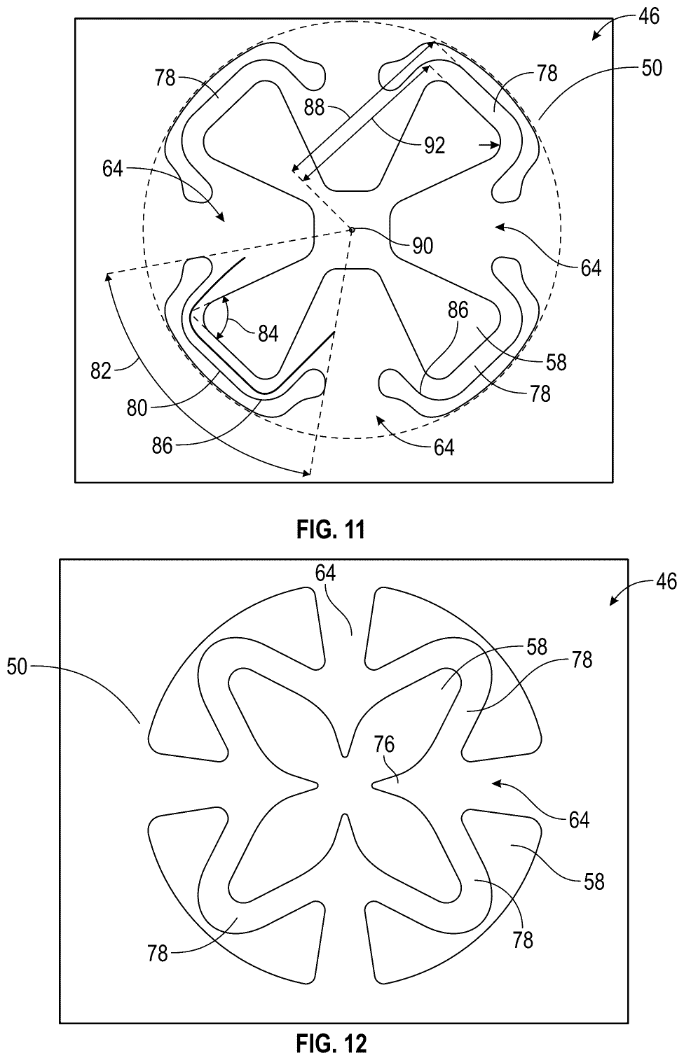

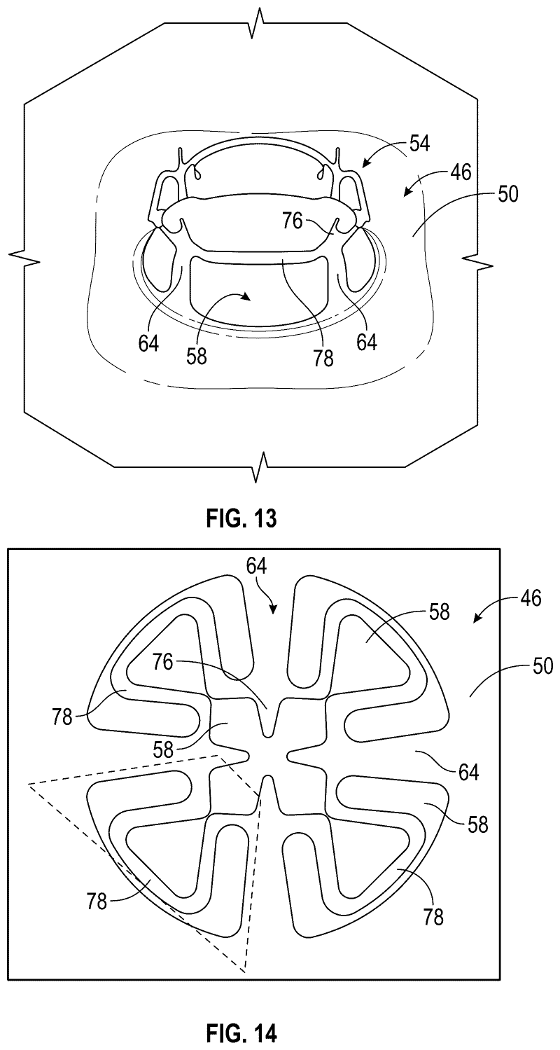

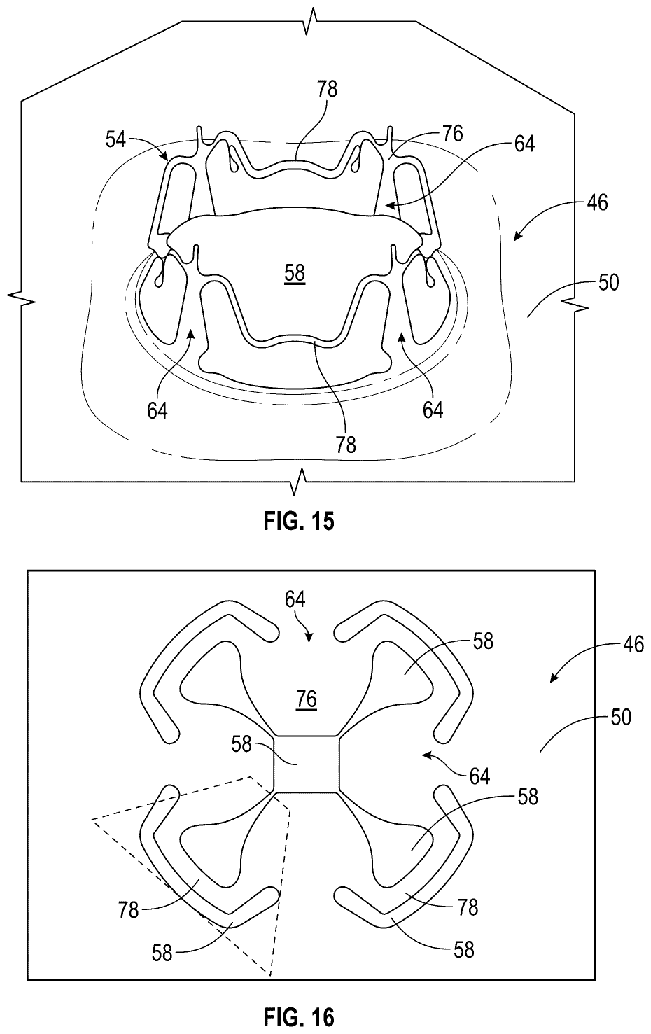

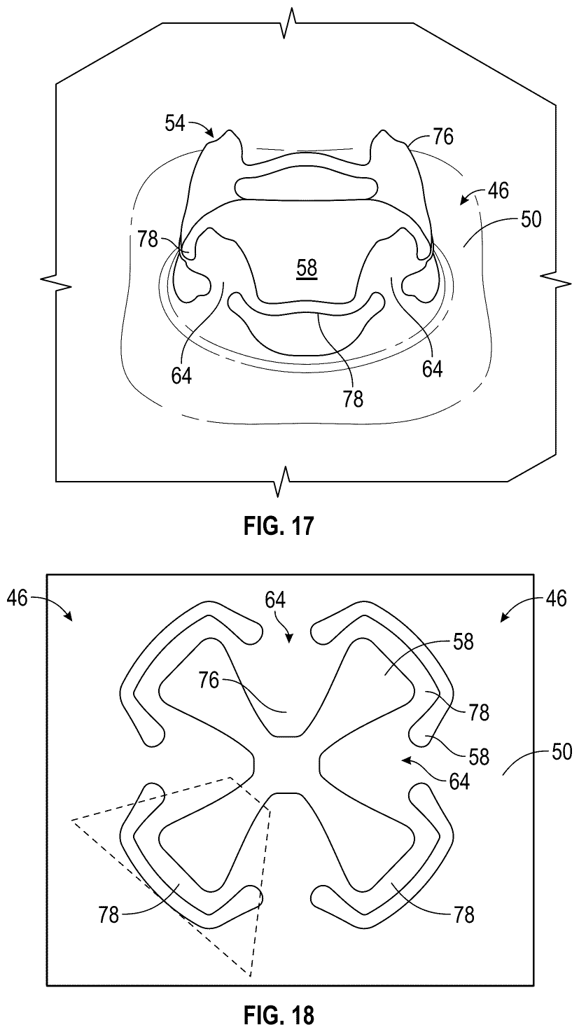

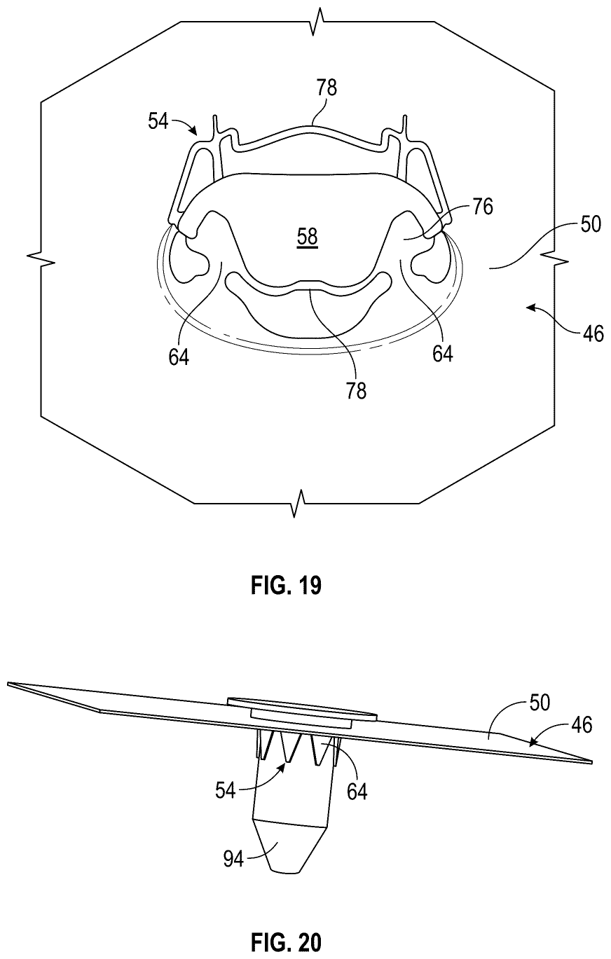

Exemplary embodiments of locating bosses 54 including leg bridges 78 are illustrated in FIGS. 12-19. In the embodiment of FIGS. 12 and 13, the leg bridges 78 are each formed with a parabolic shape as shown in FIG. 12, which when the locating boss 54 is formed to the extended position as in FIG. 13, results in the leg bridge 78 having a substantially linear configuration extending between adjacent boss legs 64. In the embodiment of FIGS. 14 and 15, the leg bridges 78 are formed in a clover leaf shape, which as shown in FIG. 15 results in the leg bridge 78 having a W shape when the locating boss 54 is formed to the extended position. In the embodiments of FIGS. 16-19, the leg bridges 78 are formed with a U-shape as illustrated in FIGS. 16 and 18. When the locating boss 54 is formed to the extend position as illustrated in FIGS. 17 and 19, respectively, the leg bridges 78 have a flattened U-shape.

While in some embodiments, the locating bosses 54 alone are used to located the cover 46 to the tray 42, in other embodiments as illustrated in FIG. 20, locating pins 94 are installed in the boss opening 58 and are supported by the legs 64 of the locating boss 54. The locating pin 94 is then utilized in combination with the locating boss 54 to locate the cover 46 to the tray 42.

To form the locating boss 54, a cutout pattern defining the boss legs 56 and, if included, the leg bridges 78, is formed in a flat state by, for example, die cutting, punching, laser cutting, waterjet cutting, or the like. After forming the cutout pattern, the locating boss 54 is then formed to the extended position. This may be accomplished via, for example, a conical or flat punch and die operation. Tolerances between the punch and die are selected and maintained to achieve a selected amount of ironing of the material during the forming operations. Tool inserts or local modifications to the punch and/or die may be performed without completely remaking the forming tools, thus providing a tooling cost savings.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on”another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A sheet metal component assembly, comprising:
a first component having at least one locating opening formed therein; and
a second component installed to the first component, the second component including:
a second component body; and
at least one locating boss formed in and extending from the second component body, the at least one locating boss installed into the at least one locating opening to position the second component at the first component.

2. The sheet metal component assembly of claim 1, wherein the at least one locating boss is one of a continuous cylindrical or conical element extending from the second component body.

3. The sheet metal component assembly of claim 1, wherein the at least one locating boss includes two or more discontinuous boss legs extending from the second component body.

4. The sheet metal component assembly of claim 3, further comprising at least one leg bridge spaced apart from the second component body and connecting two adjacent boss legs of the two or more discontinuous boss legs.

5. The sheet metal component assembly of claim 4, wherein the at least one leg bridge is one of substantially linear, W-shaped or U-shaped.

6. The sheet metal component assembly of claim 1, further comprising at least one locating pin installed in the at least one locating boss and extending into the at least one locating opening.

7. The sheet metal component assembly of claim 1, wherein the at least one locating boss is formed via one or more of die cutting, punching, laser cutting, waterjet cutting, hole extrusion or flanging.

8. A rechargeable energy storage system (RESS), comprising:
a tray;
one or more RESS cells positioned on the tray; and
a cover installed to the tray to enclose the RESS, the cover including:
a cover body; and
at least one locating boss formed in and extending from the cover body, the at least one locating boss installed into at least one locating opening in the tray to position the cover at the tray.

9. The RESS of claim 8, wherein the at least one locating boss is one of a continuous cylindrical or conical element extending from the cover body.

10. The RESS of claim 8, wherein the at least one locating boss includes two or more discontinuous boss legs extending from the cover body.

11. The RESS of claim 10, further comprising at least one leg bridge spaced apart from the cover body and connecting two adjacent boss legs of the two or more discontinuous boss legs.

12. The RESS of claim 11, wherein the at least one leg bridge is one of substantially linear, W-shaped or U-shaped.

13. The RESS of claim 8, further comprising at least one locating pin installed in the at least one locating boss and extending into the at least one locating opening.

14. The RESS of claim 8, wherein the at least one locating boss is formed via one or more of die cutting, punching, laser cutting, waterjet cutting, hole extrusion or flanging.

15. A vehicle comprising:
a vehicle body;
a propulsion system to drive a movement of the vehicle; and
a rechargeable energy storage system operably connected to the propulsion system to power the propulsion system, the rechargeable energy storage system including:
a tray;
one or more rechargeable energy storage system cells positioned on the tray; and
a cover installed to the tray to enclose the rechargeable energy storage system, the cover including:
a cover body; and
at least one locating boss formed in and extending from the cover body, the at least one locating boss installed into at least one locating opening in the tray to position the cover at the tray;
wherein at least one of the cover and the tray are formed from a sheet metal material.

16. The vehicle of claim 15, wherein the at least one locating boss is one of a continuous cylindrical or conical element extending from the cover body.

17. The vehicle of claim 15, wherein the at least one locating boss includes two or more discontinuous boss legs extending from the cover body.

18. The vehicle of claim 17, further comprising at least one leg bridge spaced apart from the cover body and connecting two adjacent boss legs of the two or more discontinuous boss legs.

19. The vehicle of claim 18, wherein the at least one leg bridge is one of substantially linear, W-shaped or U-shaped.

20. The vehicle of claim 15, further comprising at least one locating pin installed in the at least one locating boss and extending into the at least one locating opening.
